(19) United States
(12) Patent Application Publication
(10) Pub. No.: US 2025/0355827 A1
(43) Pub. Date: Nov. 20, 2025

(54) Smart Serial Bus Interface Circuit

(71) Applicant: Mellanox Technologies, Ltd., Yokneam (IL)

(72) Inventors: Itay Kuperstein, Haifa (IL); Yaniv Strassberg, Yokneam Illit (IL); Roman Meltser, Atlit (IL)

(21) Appl. No.: 18/668,320

(22) Filed: May 20, 2024

(51) Int. Cl. G06F 13/42

(52) U.S. Cl. CPC G06F 13/4282; G06F 2213/0016

(57) ABSTRACT

An apparatus includes a serial bus and a serial bus interface circuit. The serial bus is to connect to at least one device. The serial bus interface circuit is to receive a sequence of serial-bus-interface read instructions from a processor, to forward the serial-bus-interface read instructions over the serial bus to the at least one device, to buffer data elements, which are received over the serial bus from the at least one device in response to the serial-bus-interface read instructions, and to make the buffered data elements available to the processor.

### TECHNICAL FIELD

The present description relates generally to computer systems, and specifically to offloading serial bus handling tasks from processors of a computer system.

### BACKGROUND

Computer systems sometimes interface with peripheral devices through a serial bus, using serialized data packets. Standard serial buses include, for example, Inter-Integrated Circuit (I2C) bus, Improved Inter Integrated Circuit (I3C) bus, Serial Peripheral Interface (SPI), Universal Asynchronous Receiver-Transmitter (UART) and many others.

For an I2C introduction, the reader is referred to NXP Semiconductors “UM10204 I2C-bus specification and user manual”, Rev. 7.0 (Oct. 1, 2021), chapters 1 through 3 (pages 1 through 29). For I3C introduction, the reader is referred to MIPI alliance “Specification for 13C Basic”, Version 1.1.1, 9 Jun. 2021, Public Release Edition, chapters 1 through 4 (pages 2 through 26).

### SUMMARY

An embodiment that is described herein provides an apparatus including a serial bus and a serial bus interface circuit. The serial bus is to connect to at least one device. The serial bus interface circuit is to receive a sequence of serial-bus-interface read instructions from a processor, to forward the serial-bus-interface read instructions over the serial bus to the at least one device, to buffer data elements, which are received over the serial bus from the at least one device in response to the serial-bus-interface read instructions, and to make the buffered data elements available to the processor.

In some embodiments, the serial bus includes an Inter-Integrated Circuit (I2C) bus or an Improved Inter Integrated Circuit (I3C) bus. In an embodiment, the serial bus interface circuit includes a Dual-Port (DP) memory to buffer the data elements received in response to the serial-bus-interface read instructions. In a disclosed embodiment, the serial bus interface circuit includes a First-In-First-Out (FIFO) memory to buffer the serial-bus-interface read instructions that are pending to be forwarded to the at least one device.

In some embodiments, the serial bus interface circuit is to detect a defined condition by analyzing at least some of the buffered data elements, and to initiate an action in response to the condition. In an example embodiment, the serial bus interface circuit is to detect the condition by calculating a statistical function over at least some of the buffered data elements. In another embodiment, the serial bus interface circuit is to detect the condition by assessing a count of the buffered data elements. In yet another embodiment, the serial bus interface circuit is to detect the condition responsively to an extremum value among at least some of the buffered data elements. In still another embodiment, the serial bus interface circuit is to send an indication to the processor upon detecting the condition.

In disclosed embodiments, the serial bus interface circuit is also to receive, from the processor, a sequence of serial-bus-interface write instructions and respective outbound data elements, to buffer the serial-bus-interface write instructions and the outbound data elements, and to forward the buffered serial-bus-interface write instructions and the buffered outbound data elements over the serial bus to the at least one device. In some embodiments, the serial bus interface circuit is to decide whether to buffer a given data element, which is received over the serial bus, in accordance with a defined buffering condition.

There is additionally provided, in accordance with an embodiment that is described herein, a method including receiving a sequence of serial-bus-interface read instructions from a processor. The serial-bus-interface read instructions are forwarded over a serial bus to at least one device. Data elements, which are received over the serial bus from the at least one device in response to the serial-bus-interface read instructions, are buffered. The buffered data elements are made available to the processor.

The present description will be more fully understood from the following detailed description of the embodiments thereof, taken together with the drawings in which:

### BRIEF DESCRIPTION OF THE DRAWINGS

FIG. 1 is a diagram that schematically illustrates a computer system coupled to a serial bus, in accordance with an embodiment that is disclosed herein;

FIG. 2 is a block diagram that schematically illustrates a Data Analysis circuit in a Smart Serial Bus Interface Circuit (SSBIC), in accordance with an embodiment that is disclosed herein;

FIG. 3 is a block diagram that schematically illustrates a Computer System coupled to a serial bus through first-in-first-out (FIFO) memories, in accordance with an embodiment that is disclosed herein; and

FIG. 4 is a flowchart that schematically illustrates a method for smart serial bus interface, in accordance with an embodiment that is disclosed herein.

### DETAILED DESCRIPTION OF EMBODIMENTS

### Overview

Computers sometimes interface with devices over a serial bus. Serial buses are often considerably slower than processors and, hence, interfacing through the serial bus may slow the processor and degrade the performance of the computer system. For example, to watch for system overheating using an I2C thermometer device, the processor may need to continuously access the thermometer (sending serial packets that include the thermometer I2C address, with a read indication and reading the returned data), and compare the received data to a preset maximum level. In this and various other scenarios, processors may have to wait for transactions over the serial bus to complete.

For example, reading a 32-bit word from an I2C device, assuming standard 100 Khz I2C bus, takes 320μ-second just for the data (without any protocol overhead). During this time, a processor running at 1 Ghz can execute 320,000 instructions. Even at the faster versions of I3C (I3C Dual Data Rate), reading a 32-bit work still takes over 1.3μ-second, during which the processor can execute some 1, 300 instructions.

For one-time initialization of serial bus devices, the penalty in processor performance may be acceptable, but this is not the case for repeated accesses over a serial bus. For example, if a processor continuously reads an I2C thermometer to monitor the system ambient temperature, the processor run-time performance may be degraded.

Embodiments that are disclosed herein provide methods and systems that offload the processor from serial bus interface tasks. In an embodiment, the computer system comprises a Smart Serial Bus Interface Circuit (SSBIC) that is configured to receive serial-bus instructions, including parameters such as addresses, sizes, speeds etc., and, responsively, communicate with serial bus slave devices over the serial bus. In some embodiments, the SSBIC is configured to notify the processor when the SSBIC is ready to receive further serial bus instructions.

In embodiments, the SSBIC comprises a data buffer, to store data that the processor sends over the serial bus in serial bus write instructions, and to store data that the serial device returns in serial-bus read instructions; the processor can then access the data buffer and read the returned data. In an embodiment, the serial bus instruction may specify a set of conditions to store the returned data; for example, store all data from a defined subset of the serial bus devices.

In some embodiments, the SSBIC is configured to analyze the received data, for example, to calculate an average value of the read data values. In an embodiment, the SSBIC is configured to alert the processor (e.g., issue an Interrupt) if a read data value exceeds a preset extremum; or, in another embodiment, if a calculated average value exceeds the preset extremum.

In some embodiments, the processor may set the SSBIC in a cyclic mode, in which the SSBIC continuously reads a serial bus device and updates the read value in the data buffer.

For further offloading of the processor, in some embodiments, the computer system includes a FIFO memory; the processor writes the serial bus instructions in the FIFO, and the SSBIC executes the instructions from the FIFO.

Thus, in embodiments, serial bus communication loading of the processor is significantly reduced.

### System Description

We will describe hereinbelow circuits and methods that offload a processor from the task of communicating with peripheral devices through a serial bus such as Inter-Integrated Circuit (I2C) bus, Improved Inter Integrated Circuit (I3C) bus, Serial Peripheral Interface (SPI), Universal Asynchronous Receiver-Transmitter (UART) and any other suitable serial bus. In some embodiments, although not necessarily, the offloaded tasks include analysis of data that the processor may read over the serial bus.

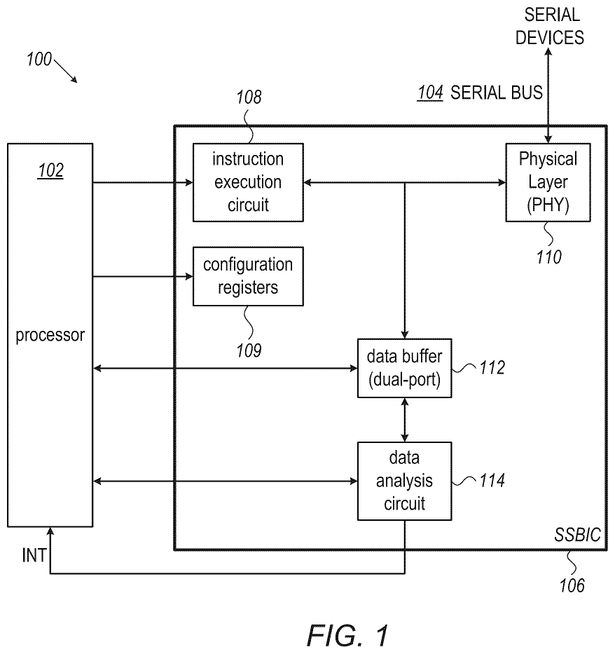

FIG. 1 is a diagram that schematically illustrates a computer system 100 coupled to a serial bus, in accordance with an embodiment that is disclosed herein. A Processor 102 (e.g., a Reduced Instruction-Set Computer (RISC)) communicates data with serial devices over a serial bus 104. In some embodiments, serial bus 104 may comprise a plurality of serial buses, of the same or of different type; for example, in an embodiment, serial bus 104 comprises a first, I3C bus, and a second bus, which may be configured in software as a I2C or and SPI bus.

In an example embodiment, the serial devices comprise an I2C thermometer that measures an ambient temperature and sends the temperature value over an I2C bus. In another example, the serial devices comprise an I3C analog-to-digital converter (ADC) that measures a voltage level (e.g., the Vcc supply voltage) and sends the voltage value over an I3C bus. Additionally, or alternatively, any other suitable serial devices can be used.

The computer system comprises a Smart Serial Bus Interface Circuit (SSBIC) 106 for communicating over the serial bus. SSBIC 106 comprises an Instruction Execution Circuit 108, and Configuration Registers 109, which are jointly configured to receive from the processor serial bus I/O instructions and translates the instructions to serial bus operations. The SSBIC is a serial bus master, initiating serial bus transactions. For example, the instruction execution circuit may receive an instruction to read the contents of the Nth register of an I2C device with address A; the instruction execution circuit will send a serial stream (comprising the device and register address), wait for an Acknowledge, and then receive the returned data.

SSBIC 106 further comprises a Physical-Layer (PHY) circuit 108. In embodiments, for I2C interface, the PHY circuit may drive the SCL (Serial Clock Line) wire, drive or sense the bidirectional SDA (Serial Data Line) wire and send ingress data to a Data Buffer 112. In some embodiments, PHY 108 is configured to retry I2C instructions that may receive a NACK (negative acknowledgement) from the serial device. In an embodiment, PHY 110 comprises voltage level converters; in embodiments that support I2C interface, the PHY may comprise passive pull-up devices, and in embodiments that support I3C interface, the PHY comprises active drivers only (in yet other embodiments, combinations of passive and active elements may be used to support a variety of serial busses and serial bus combinations).

In some embodiments, Data Buffer 112 comprises a dual-port random access memory (RAM). In serial-bus write operations, the Processor sends the write data to the Data Buffer 112, and then, the Instruction Execution Circuit sends the data from the Data Buffer to the PHY, for transmission over the serial bus. In serial bus read instructions, the Instruction Execution Circuit directs ingress data that the PHY receives from the serial-bus device to the Data Buffer, which is accessible to the processor, for further data processing.

In some embodiments, the SSBIC is configured to direct ingress data based on one or more buffering conditions that specify which ingress data is to be buffered and which ingress data is to be discarded. The buffering conditions may be sent by the processor with the serial-bus instruction, or provided in any other way. The buffering conditions may specify, for example, a predefined address range in the serial bus, pertaining to one or more serial bus devices-data read from devices in the specified address range will be directed to the data buffer. In another example, the serial bus device is a thermometer, and the buffering condition specifies a temperatures threshold for directing returned temperature readings to the buffer.

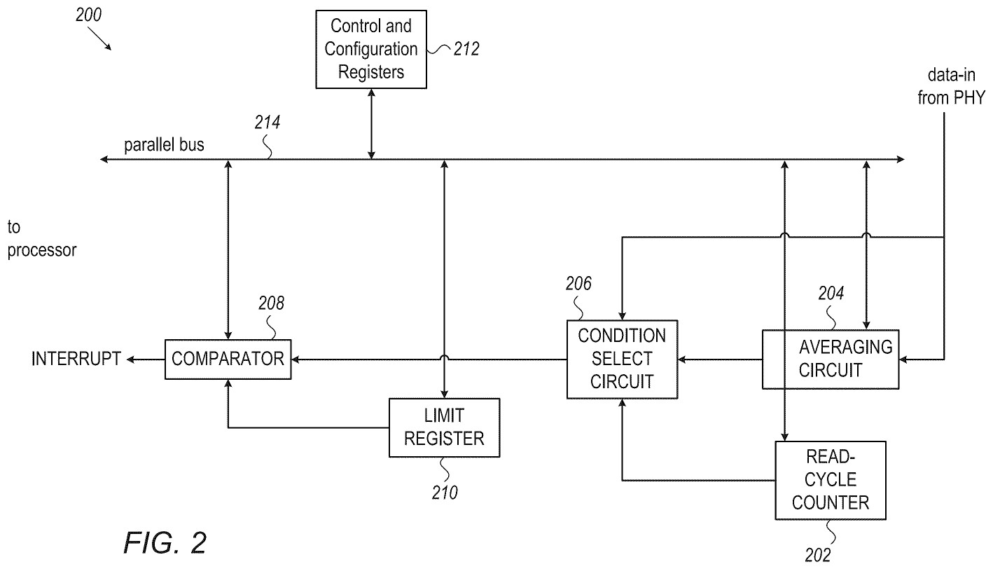

According to the example embodiment illustrated in FIG. 1, SSBIC 106 further comprises a Data Analysis circuit 114, which is configured to execute data analysis tasks on data received from the processor. Such tasks may include from a simple count of received data elements through searching of extreme (e.g., maximum or minimum) received data values, to the gathering of statistics of the input data (some examples will be described below, with reference to FIG. 2). The processor can access the Data Analysis circuit, to read the results of the analysis; alternatively, or additionally, the Data Analysis circuit may send an indication (e.g., and Interrupt) to the processor if a preset condition has occurred (e.g., a preset maximum value has been exceeded).

The configuration of computer system 100 and SBIC 106 illustrated in FIG. 1 and described herein above are cited by way of example. Other configurations may be used in alternative embodiments. For example, in some embodiments, the processor sends the data to Instruction Execution circuit 108, which then forwards the data to the Data Buffer. In some embodiments, the SSBIC does not send an Interrupt to the processor; instead, the processor may read status indications in the SSBIC registers.

### SSBIC Configurations

In embodiments, SSBIC 106 supports multiple configurations, and can operate in multiple operation modes, typically defined by configuration registers 109.

For example, the configuration registers can define the type of serial bus (e.g., I2C, I3C, etc.), including the bus speed (e.g., up to 1 Mb/s for I2C, up to 12.5 Mb/s for I3C), the size of the data buffer (possible separate sizes for read and write); in another example, the SSBIC can interface concurrently with more than one serial bus, and the configuration registers comprise multiple bus-type configuration registers; for example, in an embodiment, the configuration registers include eight registers for up to eight concurrent serial buses, each of the eight registers comprises a bus-type field, a Tx speed field, an Rx speed field, a FIFO size field, and a Completion Indication (Interrupt or Poll) field.

In some embodiments, the configuration registers may indicate that a serial bus should be operated in a cyclic mode, in which the SSBIC executes the bus transactions continuously; this may be useful when the processor needs the latest read data value (for example, when the processor accesses and I2C thermometer to read ambient temperature, the processor may want the latest measured temperature only).

Other configurations parameters include I2C sub-address width (a common width for all slaves or a specific width for each of the slaves), and a data size (common or specific per slave). In an embodiment, the configuration registers may include a clock-stretch option.

In some embodiments, the configuration registers include a size for the data buffer, for a Read and/or for a Write, for a single or for multiple serial buses.

Some of the configuration registers may be used to define the data analysis that Data Analysis circuit 114 performs on data read from the serial device. Examples for data analysis configuration will be disclosed below, with reference to FIG. 2.

### Example Data Analysis Circuit Implementation

FIG. 2 is a block diagram that schematically illustrates a Data Analysis circuit 200, in accordance with an embodiment that is disclosed herein. Circuit 200 can be used, for example, to implement Data Analysis circuit 114 in SSBIC 106 of FIG. 1 above. In the present example, Data Analysis circuit 200 comprises a Read-Cycle-Counter 202 that is configured to count the read data elements, an Averaging Circuit 204, that is configured to calculate an average value of a subset of the received elements (in some embodiments, averaging may include Infinite Impulse Response (IIR) weighted averaging), a Condition Select circuit 206, a Comparator 208 and a Limit Register 210. According to the example embodiment illustrated in FIG. 2, the Data Analysis circuit 200 supports four operating modes:
1. Read Preset-Size mode, in which the Condition Select circuit 206 forwards the read cycle count from Read Cycle Counter 202 to Comparator 208, which compares the number of read data elements to a preset values that is stored in a Limit Register 210. When the number of read data elements reaches the number stored in the Limit Register, the Data Analysis circuit may send an Interrupt to the processor (which will then typically read the data from Data Buffer 112, FIG. 1).
2. Extremum Detect mode, in which the Condition Select circuit 206 forwards the data read from the serial bus (through PHY 110, FIG. 1) to Comparator 208, which then compares the data to an extremum value stored in Limit Register 210. This mode may be useful, for example, to detect if an ambient temperature measured by an I2C thermometer is above a preset maximum level, or, for another example, if the voltage of the power supply is below a preset minimum level.
3. Averaging mode, in which the Averaging circuit 204 calculates and average of the read data values (for example, in a preset number of cycles, or, for another example, using continuous IIR averaging).
4. Average Extremum, in which the Averaging circuit 204 calculates and average of the read data values, Condition Select circuit 206 forwards the average to Comparator 208, which compares the average to a preset limit stored in Limit Register 210. This mode can be used, for example, if an average of recent temperature reading exceeds a preset level.

Data Analysis Circuit 200 further comprises a Control and Configuration Register 212 and a Parallel Bus 214. The Control Register may control the operation Averaging Circuit 204 (e.g., determine the type of averaging), the selection of the Condition Select circuit 206 and the type of comparison that Comparator 208 performs (e.g., less than, less-than-equal, greater-than, or greater-than-equal). The Control and Configuration Register 212, as well as all other Data Analysis units are accessible by the processor through parallel bus 214 (in embodiments, Control and Configuration Register 212 is included in Configuration Register 109, FIG. 1).

The configuration of Data Analysis circuit 200 illustrated in FIG. 2 and described herein above is cited by way of example. Other configurations may be used in alternative embodiments. For example, in some embodiments, the data analysis circuit is configured to analyze data from more than a single serial bus device concurrently (e.g., a serial thermometer and a serial analog to digital converter (ADC)). In embodiments, other statistics may be collected (e.g., variance).

### Buffered Operation

In some embodiments, to further offload the processor, buffered SSBIC operation, in which the processor sends a group of serial bus tasks, is used.

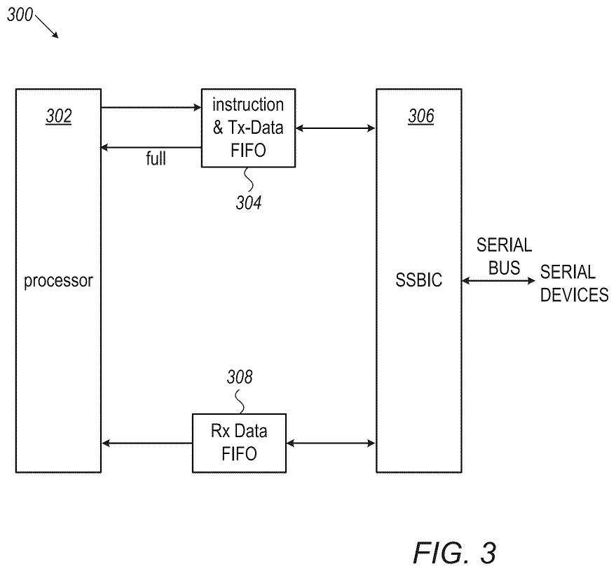

FIG. 3 is a block diagram that schematically illustrates a Computer System 300 coupled to a serial bus through first-in-first-out (FIFO) memories, in accordance with an embodiment that is disclosed herein. Processor 302 sends serial-bus instructions (including, for example, the setting of registers in the Data Analysis circuit 200, FIG. 2) to an Instruction-and-Tx-Data FIFO 304.

Computer System 300 further comprises an SSBIC 306, which is like SSBIC 106 (FIG. 1), except that SSBIC 306 receives serial bus instructions from FIFO 304 rather than directly from processor 302, and, except that, for serial bus read instructions, the SSBIC sends the received data to an Rx Data FIFO 308 rather than to the processor.

Instruction-and-Tx-Data FIFO 304 is configured to send a Full indication to the processor, to disable further writes of serial bus instructions when the FIFO is full.

Thus, according to the example embodiment illustrated in FIG. 3 and described hereinabove, the processor may issue a group of serial bus instructions, which the SSBIC converts to a set of corresponding transactions with serial bus devices over the serial bus; the processor can continue executing other instructions while the SSBIC is busy. For example, if, upon system start-up, the processor initializes a group of devices that are connected to the processor through one or more serial busses, the processor can load a corresponding set of serial bus instructions to the Instruction and Tx-Data FIFO 304, and then proceed to execute further instructions. The SSBIC may indicate to the processor when all serial bus instructions have been executed.

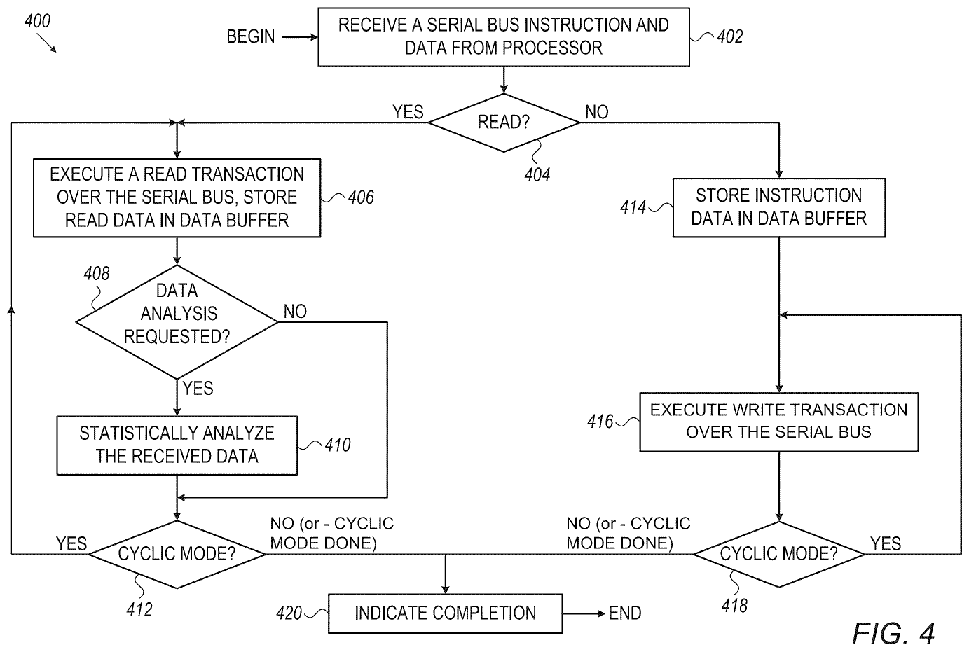

FIG. 4 is a flowchart 400 that schematically illustrates a method for smart serial bus interface, in accordance with an embodiment that is disclosed herein. The flowchart is executed by SSBIC 106 (FIG. 1).

The flowchart starts at a Receive-Serial-Bus Instruction operation 402, wherein the SSBIC receives a serial bus instruction and the corresponding data (e.g., configuration data), from a processor (e.g., processor 102, FIG. 1). The SSBIC then, in a Check Read operation 404, checks if the received serial bus instruction is a Read from a serial bus device; if so, the SSBIC will enter an Execute-Read-Transaction operation 406 and execute a read transaction according to the read instruction parameters (e.g., device address) over the serial bus, storing the read data in Data Buffer 114 (FIG. 1). The SSBIC will then, in a Check-Data-Analysis operation 408, check whether data analysis is requested (data analysis request and data analysis type may be indicated, for example, in a data analysis field of the serial bus instruction).

If, in operation 408, data analysis is requested, the SSBIC will enter a Statistical-Data-Analysis operation 410 and statistically analyze the data that the serial device sends over the serial bus (Some examples of data analysis types were described above, with reference to FIG. 2).

After operation 410 (and, after operation 408 if data analysis is not requested), the SSBIC enters a Check-Cyclic-Mode operation 412, to check if Cyclic Mode has been set for the current serial bus instruction (e.g., indicated in a Cyclic-Mode field of the Serial-Bus instruction). If so, the SSBIC will reenter operation 406, to receive further data from the serial device, and write the new data in the data buffer (replacing the stored data, so that the data buffer will always keep the last read data from the serial device).

If, in operation 404, the serial bus instruction is a Write instruction, the SSBIC enters a Store-Write-Data operation 414, and stores the Write data in the data buffer (in some embodiments, the processor sends the write data directly to the data buffer, with no SSBIC intervention). Then, at an Execute-Write-Transaction operation 416, the SSBIC executes a serial bus write transaction according to the serial-bus write instruction, and enters a Check-Cyclic-Mode operation 418. If, in operation 418, the Cyclic Mode has been set (as indicated in a respective field of the serial-bus write instruction), the SSBIC will reenter operation 416, to re-execute the serial-bus write transaction.

The mechanism to exit Cycle Mode, in both serial-bus read and serial-bus write, has not been described. In some embodiments, the number of cyclic repetitions is defined in the serial-bus instruction; in other embodiments the cyclic mode ends (in a read-serial-bus cycle) when a preset data value, or a data value exceeding a preset extremum, is received from the serial bus device.

If, in operation 412 or operation 418, Cyclic Mode is not requested (or cyclic mode has been completed), the SSBIC enters an Indicate Completion operation 420, and indicates completion to the processor. In some embodiments, completion indication may comprise asserting an Interrupt input of the processor; in other embodiments, the SSBIC sets a Done register, which may be polled by the processor.

The configuration of flowchart 400, illustrated in FIG. 4 and described herein above is cited by way of example. Other flowcharts may be used in alternative embodiments. For example, in some embodiments, the serial bus instructions that the processor sends are temporarily stored in a FIFO memory, from which the SSBIC operates.

The configuration of computer systems 100 and 300, SSBIC 106 and 200, Data Analysis circuit 200, and the method of flowchart 400, illustrated in FIGS. 1 through 4, are example configurations and flowcharts that are depicted purely for the sake of conceptual clarity. Any other suitable configurations and flowcharts can be used in alternative embodiments. The computer system, the SBBIC and components thereof may be implemented using suitable hardware, such as in one or more Application-Specific Integrated Circuit (ASIC) or Field-Programmable Gate Arrays (FPGA), using software, using hardware, or using a combination of hardware and software elements.

In some embodiments, processor 102, including components thereof, may be implemented using one or more general-purpose programmable processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

Although the embodiments described herein mainly address serial bus interface, the methods and systems described herein can also be used in other applications.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. An apparatus, comprising:
a serial bus, to connect to at least one device; and
a serial bus interface circuit, to:
receive a sequence of serial-bus-interface read instructions from a processor;
forward the serial-bus-interface read instructions over the serial bus to the at least one device;
buffer data elements, which are received over the serial bus from the at least one device in response to the serial-bus-interface read instructions; and
make the buffered data elements available to the processor.

2. The apparatus according to claim 1, wherein the serial bus comprises an Inter-Integrated Circuit (I2C) bus or an Improved Inter Integrated Circuit (I3C) bus.

3. The apparatus according to claim 1, wherein the serial bus interface circuit comprises a Dual-Port (DP) memory to buffer the data elements received in response to the serial-bus-interface read instructions.

4. The apparatus according to claim 1, wherein the serial bus interface circuit comprises a First-In-First-Out (FIFO) memory to buffer the serial-bus-interface read instructions that are pending to be forwarded to the at least one device.

5. The apparatus according to claim 1, wherein the serial bus interface circuit is to detect a defined condition by analyzing at least some of the buffered data elements, and to initiate an action in response to the condition.

6. The apparatus according to claim 5, wherein the serial bus interface circuit is to detect the condition by calculating a statistical function over at least some of the buffered data elements.

7. The apparatus according to claim 5, wherein the serial bus interface circuit is to detect the condition by assessing a count of the buffered data elements.

8. The apparatus according to claim 5, wherein the serial bus interface circuit is to detect the condition responsively to an extremum value among at least some of the buffered data elements.

9. The apparatus according to claim 5, wherein the serial bus interface circuit is to send an indication to the processor upon detecting the condition.

10. The apparatus according to claim 1, wherein the serial bus interface circuit is also to:
receive, from the processor, a sequence of serial-bus-interface write instructions and respective outbound data elements;
buffer the serial-bus-interface write instructions and the outbound data elements; and
forward the buffered serial-bus-interface write instructions and the buffered outbound data elements over the serial bus to the at least one device.

11. The apparatus according to claim 1, wherein the serial bus interface circuit is to decide whether to buffer a given data element, which is received over the serial bus, in accordance with a defined buffering condition.

12. A method, comprising:
receiving a sequence of serial-bus-interface read instructions from a processor;
forwarding the serial-bus-interface read instructions over a serial bus to at least one device;
buffering data elements, which are received over the serial bus from the at least one device in response to the serial-bus-interface read instructions; and
making the buffered data elements available to the processor.

13. The method according to claim 12, further comprising buffering the serial-bus-interface read instructions, which are pending to be forwarded to the at least one device, in a First-In-First-Out (FIFO) memory.

14. The method according to claim 12, further comprising detecting a defined condition by analyzing at least some of the buffered data elements, and initiating an action in response to the condition.

15. The method according to claim 14, wherein detecting the condition comprises calculating a statistical function over at least some of the buffered data elements.

16. The method according to claim 14, wherein detecting the condition comprises assessing a count of the buffered data elements.

17. The method according to claim 14, wherein detecting the condition is performed responsively to an extremum value among at least some of the buffered data elements.

18. The method according to claim 14, wherein initiating the action comprises sending an indication to the processor upon detecting the condition.

19. The method according to claim 12, further comprising:
receiving, from the processor, a sequence of serial-bus-interface write instructions and respective outbound data elements;
buffering the serial-bus-interface write instructions and the outbound data elements; and
forwarding the buffered serial-bus-interface write instructions and the buffered outbound data elements over the serial bus to the at least one device.

20. The method according to claim 12, wherein buffering the data elements comprises deciding whether to buffer a given data element, which is received over the serial bus, in accordance with a defined buffering condition.
